(19) United States
(12) Patent Application Publication
(10) Pub. No.: US 2002/0024189 A1
(43) Pub. Date: Feb. 28, 2002

(54) Swivel wheel mounting arrangement for travel bag

(76) Inventor: Pen-I Chen, Panchiao City (TW)

Correspondence Address: Rosenberg, Klein & Lee, 3458 Ellicott Center Drive-Suite 101, Ellicott City, MD, 21043, US

(21) Appl. No.: 09/754,058

(22) Filed: Jan. 5, 2001

(30) Foreign Application Priority Data
Aug. 30, 2000 (TW) 89215018

(51) Int. Cl. B62B 1/14

(52) U.S. Cl. 280/79.2; 190/18 A

(57) ABSTRACT

A swivel wheel mounting arrangement includes two wheel mounts bilaterally fastened to the outside wall of the bottom panel of a travel bag to hold a respective pair of swivel wheels, the wheel mounts each having a mounting frame fixedly fastened to the outside wall of the bottom panel of the travel bag, two protruded portions horizontally bilaterally extended from an inner side of the mounting frame, and two hollow posts respectively integral with the protruded portions, a reinforcing lining mounted on the inside wall of the bottom panel of the travel bag and fixedly fastened to the hollow posts of the mounting frame, and two reinforcing bars bilaterally connected between the wheel mounts and closely attached to the outside wall of the bottom panel of the travel bag, the reinforcing bars having two distal ends respectively coupled to the hollow posts of the mounting frames of the wheel mounts.

### FIELD OF THE INVENTION

The present invention relates to travel bags and, more specifically, to a swivel wheel mounting arrangement for travel bag, which has reinforcing means to reinforce the strength of the bottom panel of the travel bag and, which fits travel bags of different sizes.

### BACKGROUND OF THE INVENTION

A variety of wheeled travel bags have been disclosed, and have appeared on the market. Regular wheeled travel bags commonly have a rectangular shape, and the wheels are installed in one side panel or the bottom panel. FIGS. from 5 through 7 show a swivel wheel mounting arrangement for travel bag according to the prior art. As illustrated, a wheel mount 80 is fixedly to one side panel of the travel bag's body 7 to hold a respective swivel wheel 8. The wheel mount 80 comprises a substantially L-shaped mounting frame 81 fitting over one corner of the body 7, a convex portion 82 formed integral with the mounting frame 81 and fitted into a recessed portion of the body 7, and a flange 83 perpendicularly extended from the mounting frame 81 around the convex portion 82. The swivel wheel 8 comprises a mounting plate 86 fixedly fastened to the convex portion 82 of the wheel mount 80, a pivot shaft 85 riveted to the center of the mounting plate 86, a wheel holder 84 coupled to the pivot shaft 85, the wheel holder 84 comprising a center through hole 841, which receives the pivot shaft 85, ball chambers 842 at the top side thereof around the center through hole 841, and two parallel bottom lugs 843, a plurality of steel balls 862 respectively rotated in the ball chambers 842 of the wheel holder 84, a cover plate 861 covered on the ball chambers 842 and retained between the wheel holder 84 and the mounting plate 86 around the pivot shaft 85, a wheel axle 90 connected between the bottom lugs 843 of the wheel holder 84, two axle bearings 87 mounted on the wheel axle 90 between the bottom lugs 843 of the wheel holder 84, a wheel 89 supported on the axle bearings 87 at the wheel axle 90, and a bushing 88 mounted within the wheel 89 and supported on the axle bearing 87. Because the swivel wheel 8 is mounted with a respective wheel mount 80 to the travel bag's body 7 and no reinforcing means is provided to support the wheel mount 80 on the travel bag's body 7, the wheel mount 80 and/or the swivel wheel 8 tends to be forced to deform by an external object when moving the travel bag on the floor. If the wheel mounts of the travel bag are An deformed and not in perfect alignment, the swivel wheels of the travel bag cannot be smoothly moved in same direction. There is also known another swivel wheel mounting arrangement according to the prior art in which four swivel wheels are installed in four corners of a wheel plate, which is in turn fixedly fastened to one side panel of the body of the travel bag. However, this structure fits one particular size of travel bag only. Further, the manufacturing cost of this design is high.

### SUMMARY OF THE INVENTION

The invention has been accomplished to provide a swivel wheel mounting arrangement for travel bag, which eliminates the aforesaid drawbacks. It is one object of the present invention to provide a swivel wheel mounting arrangement, which fits travel bags of different sizes. It is another object of the present invention to provide a swivel wheel mounting arrangement, which has means to reinforce the body of the travel bag and the swivel wheels. To achieve these and other objects and according to one aspect of the present invention, the swivel wheel mounting arrangement for travel bag comprises two wheel mounts bilaterally fastened to the outside wall of the bottom panel of a travel bag to hold a respective pair of swivel wheels, the wheel mounts each having a mounting frame fixedly fastened to the outside wall of the bottom panel of the travel bag, two protruded portions horizontally bilaterally extended from an inner side of the mounting frame, and two hollow posts respectively integral with the protruded portions, and two reinforcing bars bilaterally connected between the wheel mounts and closely attached to the outside wall of the bottom panel of the travel bag, the reinforcing bars each having two distal ends respectively coupled to the hollow posts of the mounting frames of the wheel mounts. According to another aspect of the present invention, a reinforcing lining is mounted on the inside wall of the bottom panel of the travel bag and fixedly fastened to the hollow posts of the mounting frame to reinforce the bottom panel of the travel bag.

### BRIEF DESCRIPTION OF THE DRAWINGS

FIG. 1 is a perspective view of a swivel wheel mounting arrangement according to the present invention.

FIG. 2 is an exploded view of the swivel wheel mounting arrangement shown in FIG. 1.

FIG. 3 is a sectional side view in an enlarged scale of the swivel wheel mounting arrangement shown in FIG. 1.

FIG. 4 is a perspective view of an alternate form of the present invention.

FIG. 5 is an exploded view of a swivel wheel mounting arrangement according to the prior art.

FIG. 6 is a perspective bottom view of the assembly of the prior art swivel wheel mounting arrangement shown in FIG. 5.

FIG. 7 is a sectional view of the prior art.

### DETAILED DESCRIPTION OF THE PREFERRED EMBODIMENT

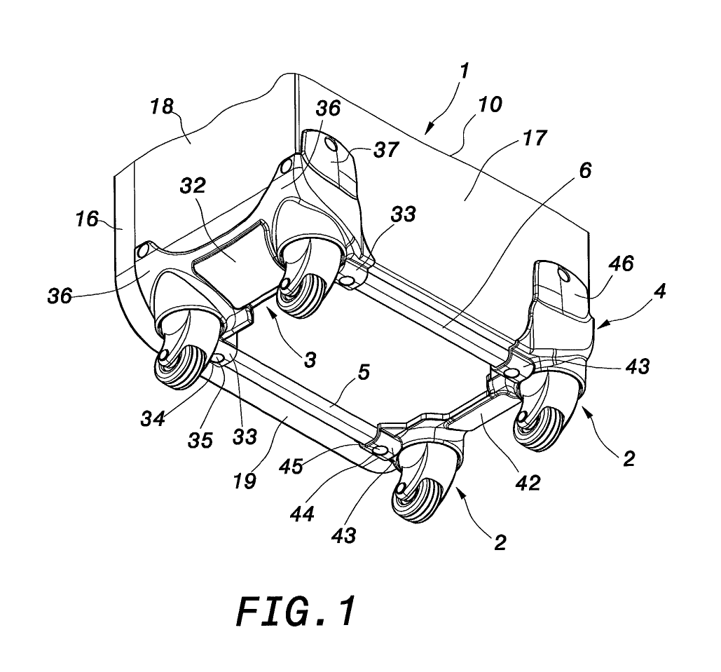

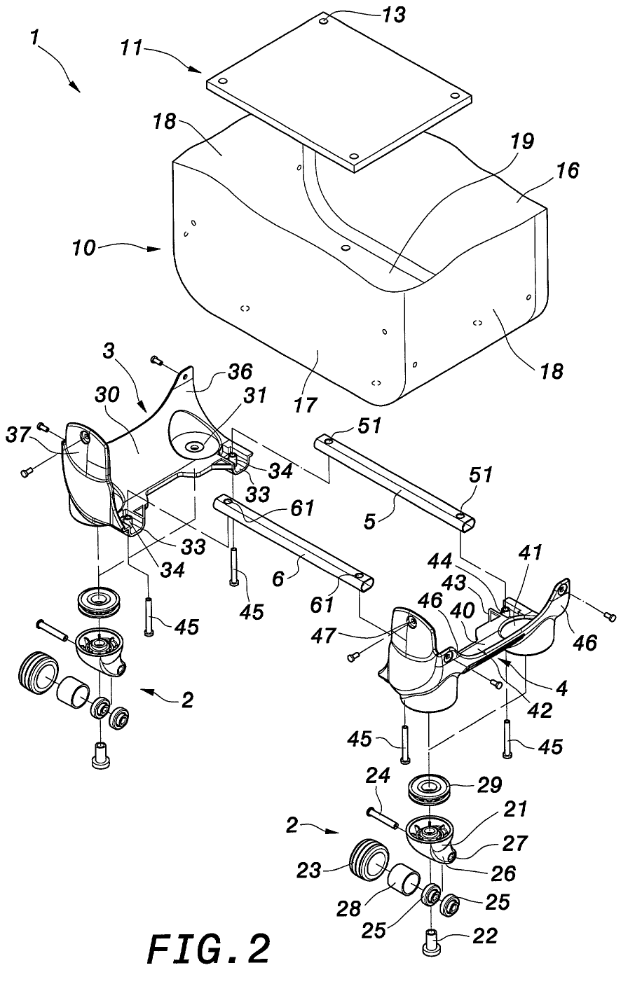

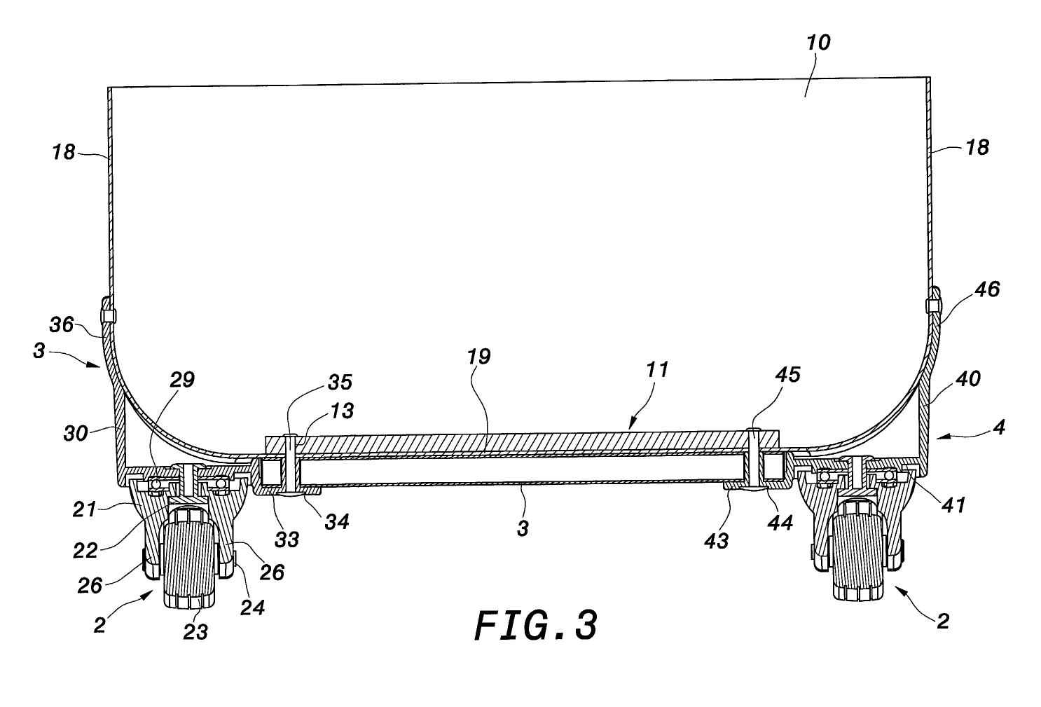

Referring to FIGS. 1 to 4, two wheel mounts, 3 and 4 are transversely fastened to the bottom panel 19 of the body 10 of a travel bag 1 at two sides to hold a respective pair of swivel wheels 2, i.e., one swivel wheel 2 is respectively installed in each of the four corners of the bottom panel 19 of the body 10 of the travel bag 1. Each swivel wheel 2 comprises a pivot shaft 22 vertically riveted to one end of the mounting frame 3 or 4, a ball bearing 39 turned about the pivot shaft 22 and closely attached to the wheel mount 3 or 4, a wheel holder 21 coupled to the pivot shaft 22 and supported on the ball bearing 29 for synchronous rotation with the ball bearing 29 about the pivot shaft 22, the wheel holder 21 comprising two bottom lugs 26 each having an axle hole 27, a wheel axle 24 installed in the axle hole 27 of each bottom lug 26 of the wheel holder 21, two axle bearings 25 mounted on the wheel axle 24 between the lugs 26 of the wheel holder 21, a wheel 23 supported on the axle bearings 25 at the wheel axle 24 and adapted to be turned about the wheel axle 24, and a bushing 28 mounted within the wheel 23 and supported on the axle bearing 25.

The wheel mount 3 or 4 comprises a mounting frame 30 or 40 fastened to the body 10 of the travel bag 1. The mounting frame 30 or 40 comprises a base 32 or 42 closely attached to the bottom panel 19 of the body 10 of the travel bag 1, two first mounting portions 36 or 46 respectively extended from two distal ends of the base 32 or 42 and respectively fixedly fastened to the side panels 18 of the body 10 of the travel bag 1, a second mounting portion 37 or 47 upwardly extended from one first mounting portion 36 or 46 and fixedly fastened to the back panel 17 of the body 10 of the travel bag 1, two axle holders 31 or 41 respectively formed integral with the connection areas between the base 32 or 42 and the first mounting portions 36 or 46 and adapted to receive the pivot shafts 22 of the corresponding swivel wheels 2, two protruded portions 33 or 43 respectively horizontally extended from the periphery of the axle holders 31 or 41 at an inner side, and two hollow posts 34 respectively formed integral with the protruded portions 33 or 43. The first mounting portions 36 and 46 have a curved shape fitting over the bottom corners of the body 10 of the travel bag 1.

Further, a reinforcing lining 11 is to the inside wall of the bottom panel 19 of the body 10 of the travel bag 1, and two reinforcing bars 5 and 6 bilaterally connected between the wheel mounts 3 and 4. The reinforcing bars 5 and 6 each have two mounting holes 51 or 61 disposed at two distal ends and respectively coupled to the hollow posts 34 and 44 of the wheel mounts 3 and 4. Fastening elements 45 are respectively installed in the hollow posts 34 and 44, the mounting holes 51 and 61 of the reinforcing bars 5 and 6 and respective mounting holes 13 of the reinforcing lining 11 to fixedly secure the wheel mounts 3 and 4, the reinforcing bars 5 and 6 and the reinforcing lining 11 to the bottom panel 19 of the body 10 of the travel bag 1.

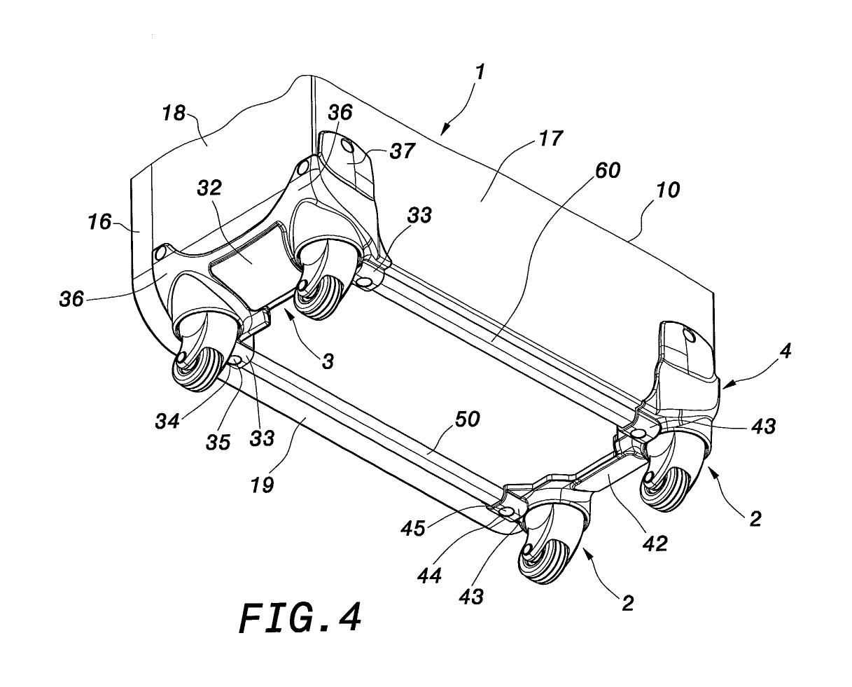

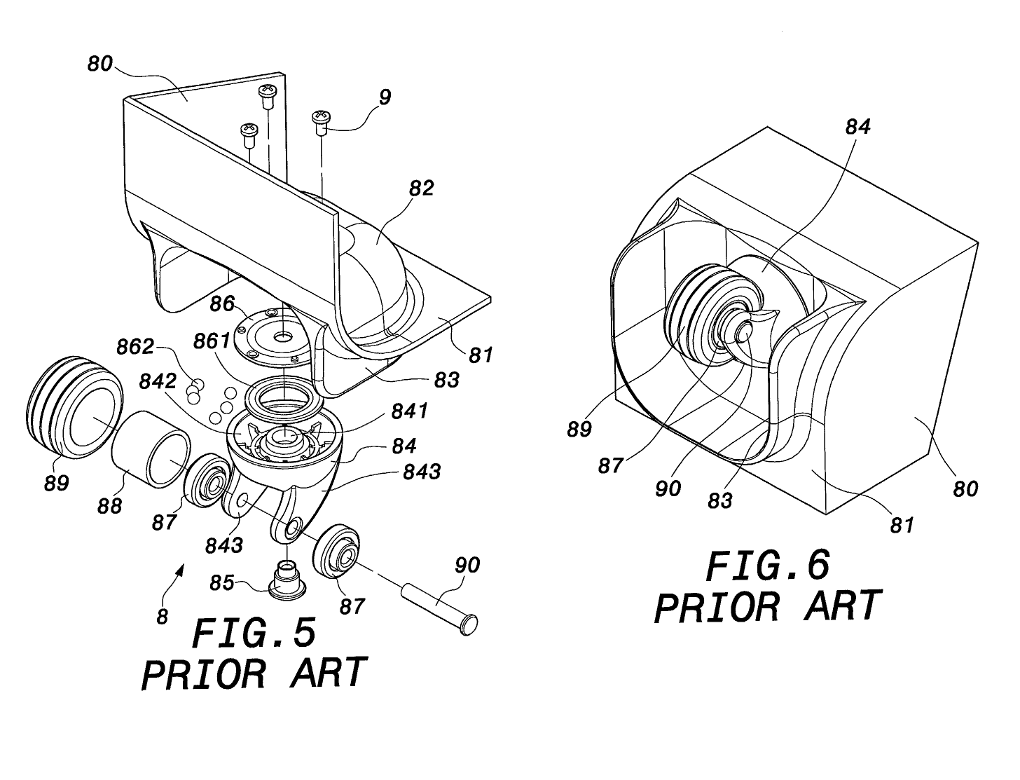

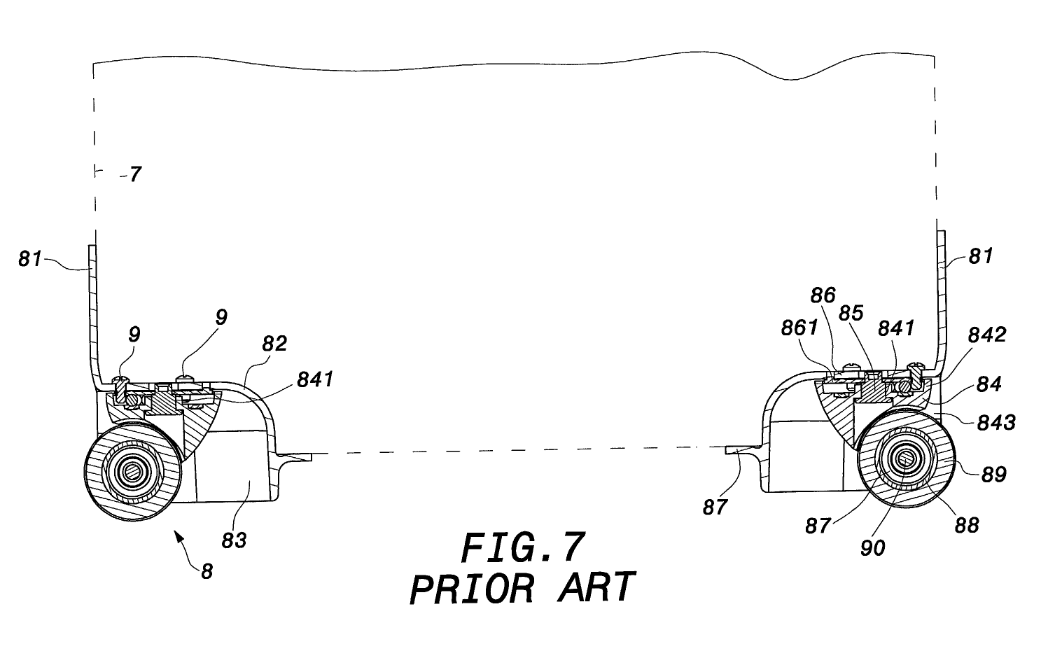

Because the wheel mounts 3 and 4 are fastened with the reinforcing bars 5 and 6 and the reinforcing lining 11 to the bottom panel 19 of the body 10 of the travel bag 1, the body 10 of the travel bag 1 is strong enough to carry a heavy. Further, the length of the reinforcing bars 5 and 6 is determined subject to the size of the travel bag 1, i.e., the wheel mounts 3 and 4 can be used with different lengths of reinforcing bars 5 and 6 to fit different sizes of travel bags 1 (FIGS. 1 and 4 show two travel bags of different sizes).

While only one embodiment of the present invention has been shown and described, it will be understood that various modifications and changes could be made thereunto without departing from the spirit and scope of the invention disclosed.

What is claimed is:

1. A swivel wheel mounting arrangement comprising:
two wheel mounts bilaterally fastened to an outside wall of a bottom panel of a travel bag to hold a respective pair of swivel wheels, said wheel mounts each comprising a mounting frame fixedly fastened to a bottom panel of the travel bag, two protruded portions horizontally bilaterally extended from an inner side of said mounting frame; and
two reinforcing bars bilaterally connected between said wheel mounts, said reinforcing bars each having two distal ends respectively fastened with the protruded portions of said wheel mounts to the bottom panel of the travel bag.

2. The swivel wheel mounting arrangement of claim 1 wherein the mounting frame of each of said wheel mounts comprises a base, and two wheel holders formed integral with two distal ends of said base and adapted to hold a respective swivel wheel.

3. The swivel wheel mounting arrangement of claim 1 wherein said wheel mounts each comprises two hollow posts respectively formed integral with the respective protruded portions and fastened to the respective mounting holes of said reinforcing bars and the bottom panel of the travel bag.

4. The swivel wheel mounting arrangement of claim 3 further comprising a reinforcing lining mounted inside the travel bag and fixedly fastened to the hollow posts of said wheel mounts.

5. The swivel wheel mounting arrangement of claim 1 wherein said wheel mounts each comprise two first mounting portions respectively fastened two side panels of the travel bag, said first mounting portions having a curved shape respectively fitting over bottom corners of the travel bag.

6. The swivel wheel mounting arrangement of claim 5 wherein said wheel mounts each further comprise a second mounting portion upwardly extended from one first mounting portion and fixedly fastened to a back panel of the travel bag.
